(19) United States
(12) Patent Application Publication
(10) Pub. No.: US 2016/0183507 A1
(43) Pub. Date: Jun. 30, 2016

(54) FISHING LINE STORAGE AND REVERSAL

(71) Applicant: Taylor McKenzie Morehead, Gurdon, AR (US)

(72) Inventor: Taylor McKenzie Morehead, Gurdon, AR (US)

(21) Appl. No.: 14/586,057

(22) Filed: Dec. 30, 2014

(51) Int. Cl. A01K 89/00; A01K 97/06; A01K 99/00; A01K 91/06

(52) U.S. Cl. CPC A01K 89/003; A01K 91/06; A01K 97/06; A01K 99/00

(57) ABSTRACT

A device for storing fishing line, including a housing supporting a plurality of axle-rods, each having a crank-handle at one end and supporting a plurality of spools each of which is aligned with a spool supported by an adjacent axle-rod. Each of the spools configured to accept fishing line fed thereon, preferably from an angle not substantially parallel to an axle-rod.

### CROSS REFERENCE TO RELATED APPLICATIONS

Not applicable.

### FEDERALLY SPONSORED RESEARCH AND DEVELOPMENT

Not Applicable.

### MICROFICHE APPENDIX

Not Applicable.

### BACKGROUND OF THE INVENTION

(1) Field of the Invention

It is frequently necessary for fishermen to transfer a fishing line from one spool to another for more efficient use of the fishing line. And to facilitate re-use of the portion of the line that was used least when the line was initially spooled within the fishing reel, it may be necessary to transfer the fishing line to a second storage spool after the first storage spool. It is difficult for one person to make the transfer since it ideally requires that the first storage spool be placed somewhere aligned with the fishing reel, then unwind the fishing line and re-wind it onto the storage spool, then repeat that process with a second storage spool. Most of the time the fishing line tangles during the transfer, and the process can be very time consuming.

(2) Background of Invention

The present invention is a storage container for fishing line spools which also can be used as an efficient device for transferring a fishing line from the one spool to another by one person without help. The container includes an openable housing supporting at least two parallel axle-rods with crank handles. The alignment of the axle-rods in the housing permits rotation of multiple spools for efficient transfer of the fishing line, initially from the fishing reel to a first spool carried on the first axle-rod, and then (if desired) to another spool carried on the second axle-rod. The device allows fast efficient transfer of many fishing lines by one person at once, without tangling. Cranking one axle-rod after attachment of the free end of a fishing reel's line will wrap the line around the spool to remove it from the fishing reel for storage. Cranking of the other axle-rod after subsequent attachment of the newly-freed end of the line to the aligned spool will wrap the line around the aligned spool; accordingly, reattachment of the newest-freed end of the line to the fishing reel, and reeling it completely onto the fishing reel, will facilitate re-use of the portion of the line that was used least when the line was initially spooled within the fishing reel.

Known in the art are the following patents and published applications, arguably related to the patentability of the present invention:

| | | Date of Patent/ |
|---|---|---|
| U.S. Patent/App No. | 1^{st} Named Inventor | Publication |
| U.S. Pat. No. 3,876,045 | Knarreborg | 1975 Apr. 8 |
| U.S. Pat. No. 3,951,354 | Bagby | 1976 Apr. 20 |
| U.S. Pat. No. 3,962,815 | Christensen | 1976 Jun. 15 |
| U.S. Pat. No. 4,708,244 | Fish | 1987 Nov. 24 |
| U.S. Pat. No. 4,791,752 | Van Kampen | 1988 Dec. 20 |
| U.S. Pat. No. 4,795,107 | Williams | 1989 Jan. 3 |
| U.S. Pat. No. 4,998,685 | Spencer | 1991 Mar. 12 |
| U.S. Pat. No. 6,427,377 | Kim | 2002 Aug. 6 |
| EP No. 1,576,879 | Isidoro | 2004 Mar. 19 |

U.S. Pat. No. 3,951,354 issued to Bagby discloses a fishing reel loading and unloading device by which a line supply spool is supported for universal positioning relative to a rod-carried spinning reel (which has a rotating ball for winding fishing line around its stationary spool). The line supply spool is supported on a one-piece spindle with a threaded free end to extend through a line spool supported by a journal near the other end thereof received in a bearing aperture in one leg of an L-shaped standard. The line spool is equipped with a crank for rotating an empty line supply spool carried thereon, for unloading the spinning reel. The other leg of the standard is mounted for swiveling movement with respect to a supporting post portion depending from a mourning clamp capable of being secured to a suitable support of a fishing rod. The spindle journal is separated from the line spool receiving end. The L-shaped configuration of the standard, coupled with the length of the leg connected to the mounting clamp post, will enable the line spool to be centered either axially or transversely with respect to a spinning reel mounted on a rod to which the device is clamped.

U.S. Pat. No. 4,791,752 issued to Van Kampen discloses a fishing tackle storing spindle and bracket assembly for holding and storing fishing lines. The assembly comprises an elongated cylindrical spindle having an axle-rod at each end, rotatably mounted on corresponding brackets attached to the side of a tackle box drawer or boat. The spindle has longitudinally-spaced circumferential grooves around its outer surface to accept fishing lines. A crank secured to one end of the axle is used to manually rotate the spindle to wind line thereon.

U.S. Pat. No. 4,795,107 issued to Williams discloses a fishing line transfer apparatus for simultaneous or selective withdrawal of line from a first and/or second fishing reel onto a centrally located spool; alternatively, line may be transferred from a first fishing reel to an aligned central sub-spool while line may be transferred from another aligned central sub-spool (or a non-aligned supply spool) to a second fishing reel oriented. The apparatus comprises a central spool having side-by-side sub-spools, rotatably mounted between a pair of fishing reels facing each other so that line from each reel may be wound around an aligned sub-spool and/or one or both reels may be re-wound with line from an aligned sub-spool. There is a handle secured to the central axle for rotation of the central spool.

U.S. Pat. No. 6,427,377 issued to Kim discloses a fishing tackle box with line winder within one walled compartment. For winding line onto a storage spool, the tackle box includes at least one compartment having aligned vertical slots in the top of an outer wall and an opposite inner wall, for accepting a crank fitted with a spool to accepting fishing line wound thereon. The crank includes a shaft having an essentially cylindrical adapter with a grooved outer surface, to securely engage the spool having a center aperture with corresponding inner ridges. For winding fishing line back onto a spinning reel (removed from the fishing rod), the reel is fitted into a reel-receptor, which in turn mates with the crank-shaft-adapter to facilitate cranking of the reel, a spool with stored line is inserted into an adjacent compartment of the tackle box, aligned with the reel so that cranking of the reel (after attachment of the line thereto) will wind the line from the storage spool (which rotates in the adjacent compartment without any axle) onto the reel.

None of these references, standing alone, expressly discloses a device for storing spools of fishing line and, if desired, making the previously unused end available for use. None of these references discloses a housing supporting several axel-rods with aligned pairs of spools, each pair for storage-transfer of a line from the fishing reel spool to a first storage spool and from there to a second reversing spool so that the line's previously used end will be available for attachment to a fishing reel spool and the line's previously unused end made available for attachment of fishing lures or bait. By cranking a first axle-rod after attachment of the free end of a fishing reel's line (to wind it around the first spool to remove it from the fishing reel for storage), and then cranking the second axle-rod after subsequent attachment of the other end of the line to the aligned spool (to wrap the line around the aligned spool), reattachment of the newly-freed end of the line to the fishing reel, and reeling it completely into the fishing reel, will facilitate re-use of the portion of the line that was used least when the line was initially spooled within the fishing reel.

### BRIEF SUMMARY OF THE INVENTION

The invention disclosed herein is essentially a housing supporting aligned pairs of spools mourned on respective rotatable axle-rods having crank handles. In one general embodiment, it is basically an assembled box with a bottom, and four sides attached to the bottom. Two parallel sides of the box support a plurality of parallel pairs of first and second axel-rods with crank handles on the end(s) outside the box. The axel-rods are aligned for accepting pairs of first and second spools, each for accepting a fishing line. The free end of a fishing line can be attached by a clip (or other attachment mechanism) to a first spool on the first axel-rod. Cranking one axle-rod after attachment of the free end of a fishing reel's line will wrap the line around the first spool to remove it from the fishing reel for storage. Ideally the orientation of each fishing line being wound onto a spool is essentially perpendicular to the spool's axle-rod. Cranking of the other axle-rod after subsequent attachment of the other end of the line to the aligned spool will wrap the line around the aligned spool. To prevent one totaling crank handle from impacting a nearby crank handle, one axle-rod has a crank handle on a left end while the nearby axle-rod has a crank handle on an opposite end. Alternatively, sufficient separation between nearby same-side crank handles by making the separation of the axle-rods longer than the combined length of two nearby crank handles. One or more axle-rod may have crank handles on both the left and right ends, for convenient accommodation of left and right banded users.

### BRIEF DESCRIPTION OF FIGURES OF THE DRAWINGS

FIG. 1 depicts a perspective view of a representative sample of the device, in an open configuration awaiting use.

FIG. 2 depicts a front elevation view of the device of FIG. 1.

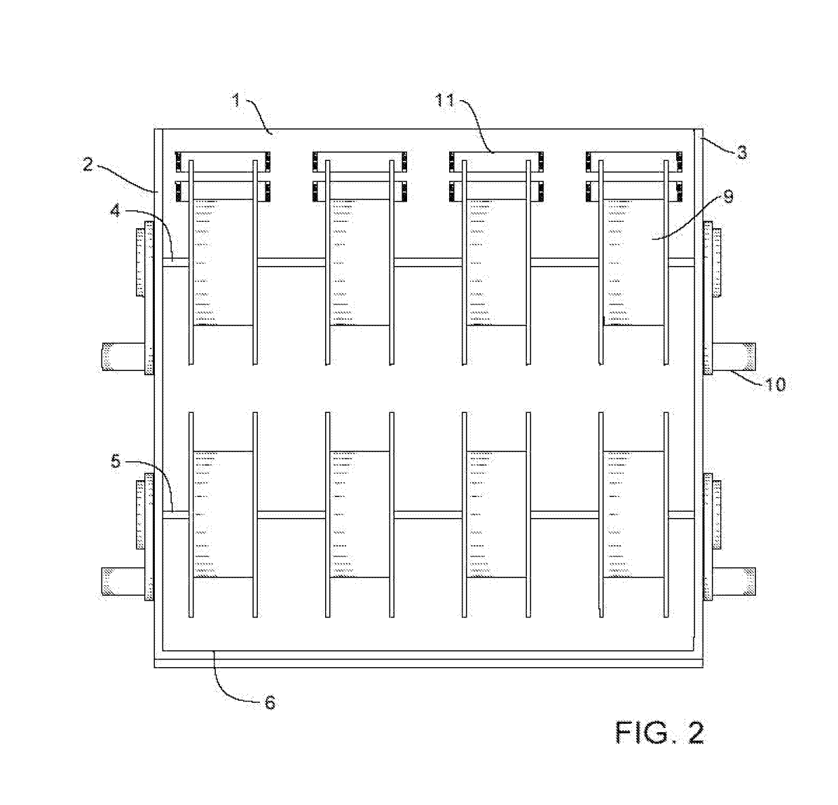

FIG. 3 depicts a rear elevation view of the device of FIG. 1.

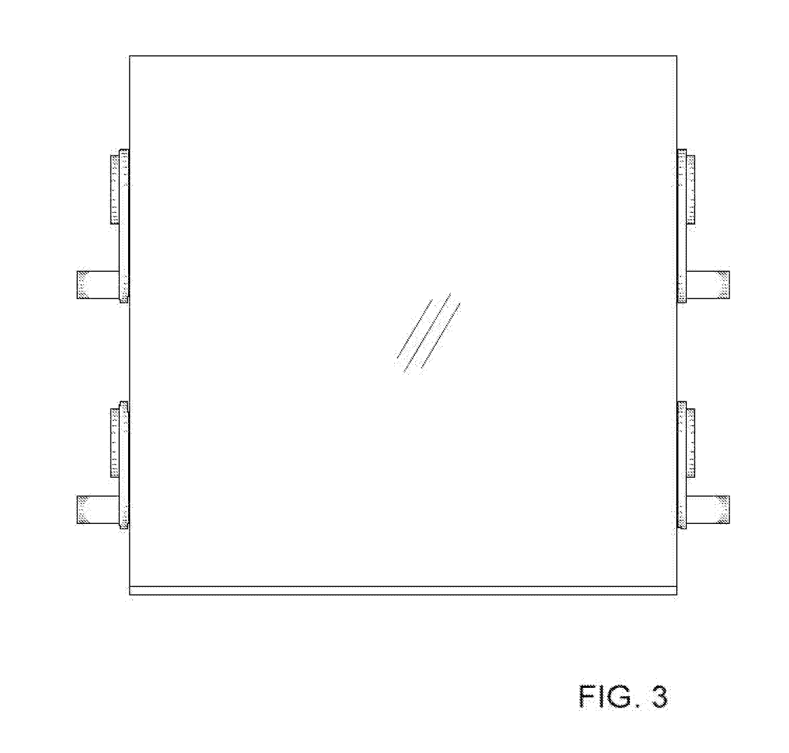

FIG. 4 depicts left side elevation view of the device of FIG. 1, with the right side elevation view being a mirror image thereof, the unclaimed fishing line appears in phantom.

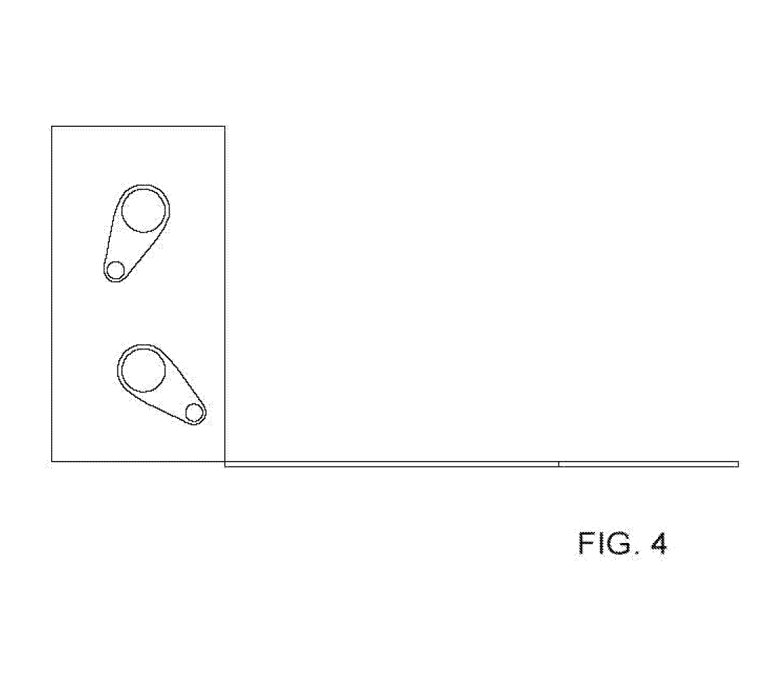

FIG. 5 depicts a top plan view of the device of FIG. 1.

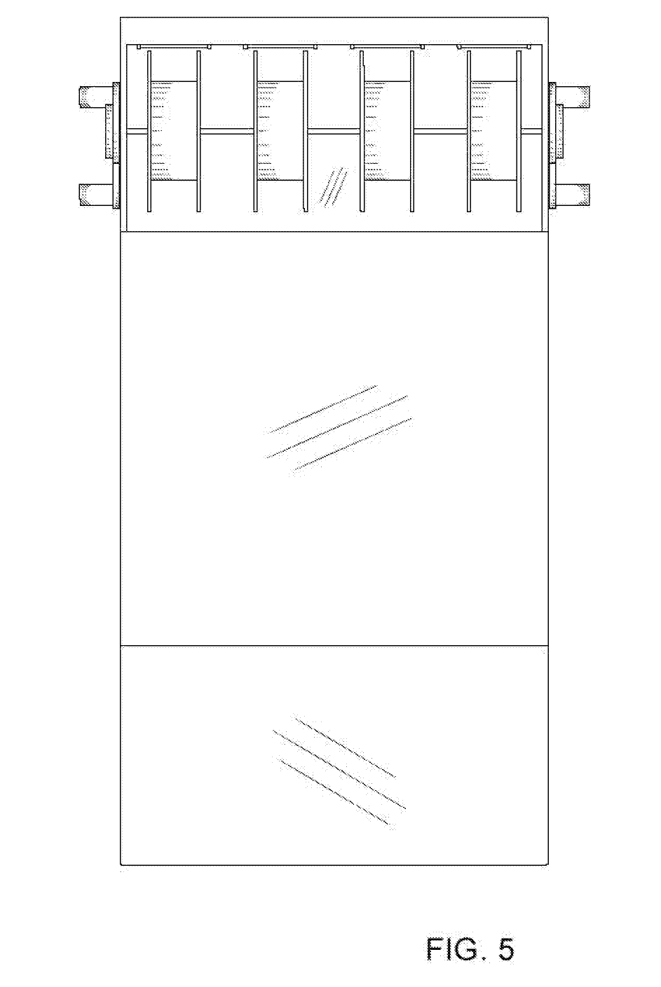

FIG. 6 depicts a bottom plan view of the device of FIG. 1.

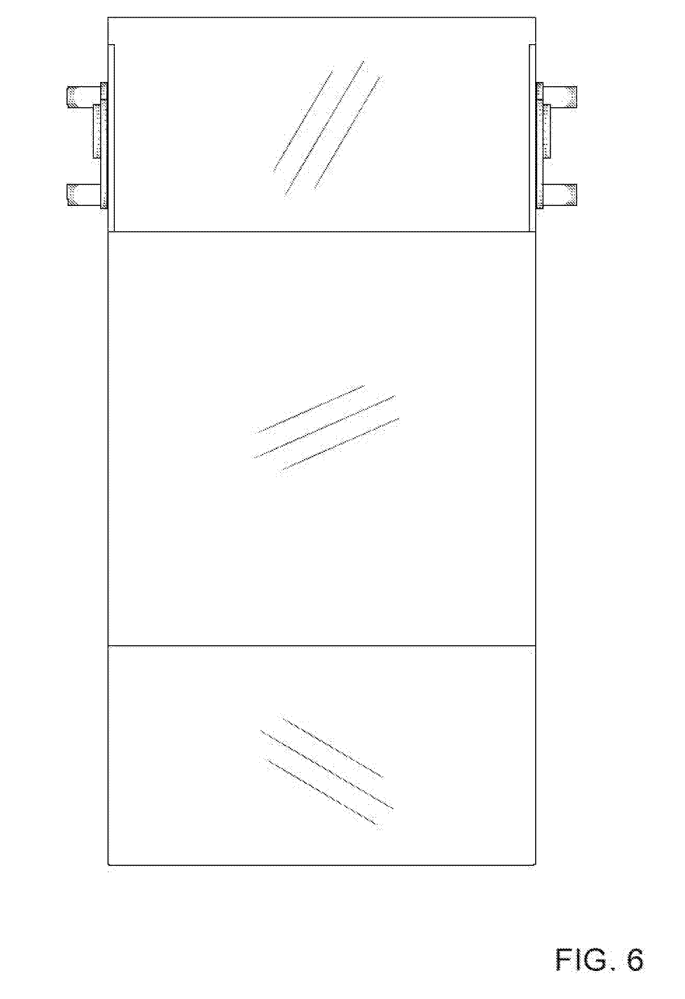

FIG. 7 depicts a perspective view of the device of FIG. 1, in a closed configuration.

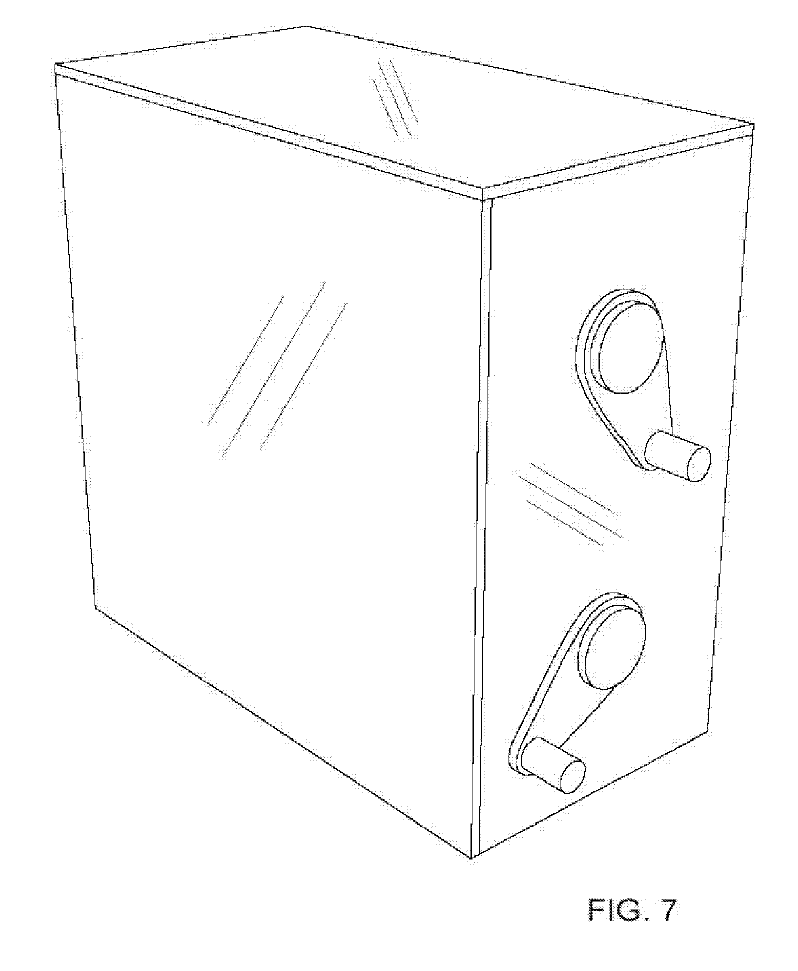

The broken lines are for illustrative purposes only, and do not form part of the claimed invention.

### DETAILED DESCRIPTION OF THE INVENTION

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element.

The disclosure herein is not limited by construction materials to the extent that such materials satisfy the structural and/or functional requirements For example, any material may be used so long as it satisfies the rigid structural and functional requirements for which it is being used. In one embodiment, the device and/or system is steel or a similar metal or alloy, however, polymeric material of sufficient strength and rigidity will suffice as well.

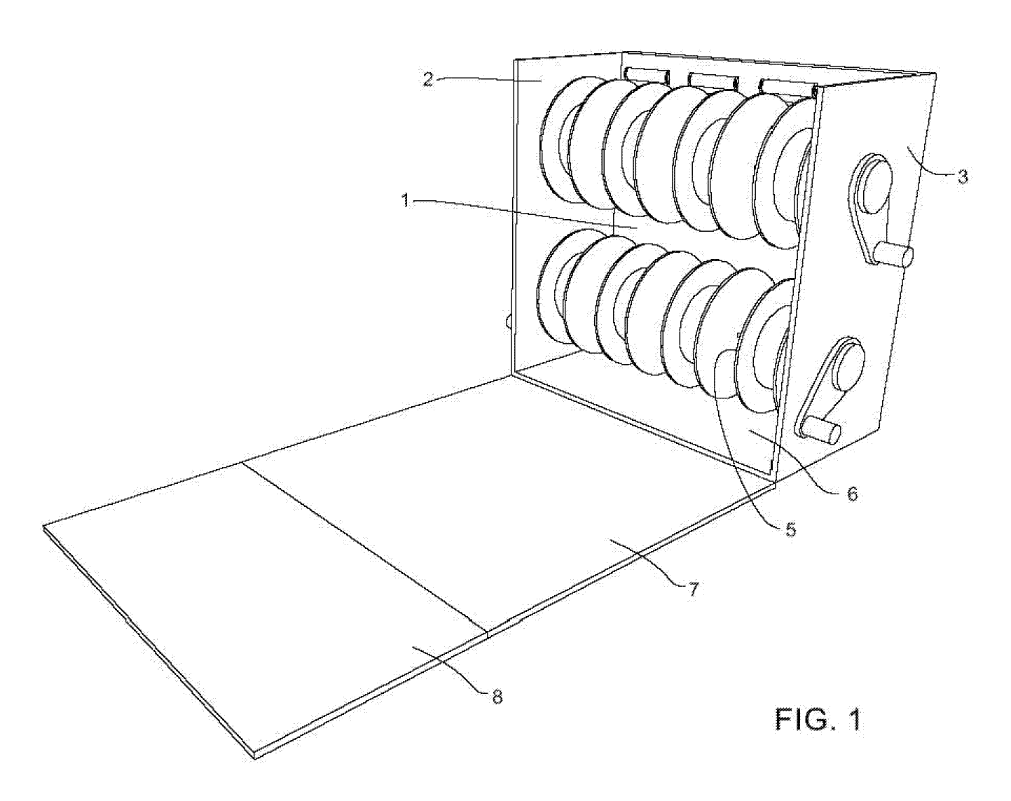

In the form of invention illustrated in FIG. 1, there is illustrated a device for storing fishing line including a base (1) to which is attached a first side (2) and a second side (3) supporting parallel tipper and lower axel-rods (4 and 5, respectively). Each axle-rod carries a plurality of spools such as spool (9). Hingedly or flexibly attached to a third side (6) is at least one cover panel (7), which may include an enclosure section (8). (Illustrated is a version having the third side and cover panel being pivotally or flexibly attached, such as may be accomplished with polymeric material, the same goes for the joinder of the cover panel and the enclosure section. However, hinges and other pivotal connections known in me art may be used as well.) The base of the box provides support for all sides of the box. The first and second sides have openings for supporting the upper and lower axle-rods inside the box while having the axle-rod ends outside the housing in a position which allows a free rotation of the respective axle-rod crank handle(s). The cover panel and enclosure section facilitates the closing of the box and storage of spools having fishing lines wound around.

The parallel axel-rods provide support for respectively aligned couples of first and second spools (9) accepting fishing line wound thereon. The fishing line may be attached to each spool by a clip or other attachment means which allows a secure transfer of fishing line to the spool. The fishing line may best be transferred to the spool from an angle not substantially parallel to an axle-rod. Each axle-rod has a crank handle (10) attached (outside the box) to the axle-rod, on the left and/or the right end for the convenience of right and left hand users. Alternately, crank handles can be placed on both right and left sides of the box.

Each pair of first and second spools is aligned to provide transfer of fishing line from the first spool of each pair to the second spool of the couple. Transfer of fishing line from the first spool to second spool is obtained from an angle not substantially parallel to an axle-rod. The number of pairs equally distributed on the axle-rod can be determined by the size of the box and the size of the spools.

After securing of a fishing line on the first spool, it is wound off the original spool (typically associated with a fishing reel) and onto the first spoof of the device. The line can then be transferred to another spool of another axle-rod of the device, preferably the spool most closely aligned with the first spool, by turning the crank handle of the second axle-rod. The simultaneous transfer of multiple fishing lines from fishing reels to the first spools of the device may be accomplished by rotation of the first axle-rod after the fishing lines are attached to their respective spool. Similarly, the simultaneous transfer of multiple fishing lines from the first spools to the second spools of the device may be accomplished by rotation of the second axle-rod after the fishing lines are attached to their respective second spool.

One embodiment of the invention disclosed herein comprises (includes) a device for storing fishing line, which may include a housing supporting at least one essentially parallel pair of first and second axle-rods supporting respective aligned first and second spools each for accepting fishing line fed thereon. Preferably the fishing line is fed from an angle not substantially parallel to an axle-rod. Each axle-rod preferably has at least one crank handle at one end.

Ideally the housing will support at least one essentially parallel pair of first and second axle-rods supporting a plurality of pairs of respective aligned first and second spools, each for accepting fishing line fed thereon. For example, one axle-rod may carry four spools (A, B, C and D), while an adjacent second axle-rod may carry aligned spools (A′, B′, C′ and D′). The housing may support a plurality of essentially parallel pairs of first and second axle-rods supporting respective aligned first and second spools, each for accepting fishing line fed thereon from an angle not substantially parallel to an axle-rod.

Each spool further may include a line anchoring means for anchoring the end of the line to the spool, such as a clip mechanism, an eyelet, a pinching slit having converging ends, a clamp or any other means capable of attaching the line to the spool during winding.

Each axle-rod may have crank handles on both ends of the rod outside the housing. Alternatively, the first axle-rod may have a right-end crank handle and the second axle-rod may have a left-end crank handle.

The housing may include a pair of opposing support walls connected by a connecting plate. Each of the support walls may define an aperture aligned with an aperture of the other support wall, for accepting opposite ends of an axle-rod inserted therethrough. The housing further may include a front wall and a rear wall connected to the connecting plate, and a lid pivotally attached to the front wall or the rear wall to facilitate storage of line spooled therein.

The device further may include indicia (11) for indicating an identifying characteristic of the line spooled thereon. For example, each spool may have a placard or other associated means of listing the identifying characteristic(s) of the line wound thereon.

The device may also include a latch and/or locking mechanism to secure the device in the enclosed configuration.

In a particularly preferred embodiment, the device for storing fishing line may include a housing supporting a plurality of axle-rods, each having a crank-handle at one end and supporting a plurality of spools each of which is aligned with a spool supported by an adjacent axle-rod; each of the spools may accept a fishing line fed thereon from an angle not substantially parallel to an axle-rod. The spool further may include a line anchoring means for anchoring the end of the line to the spool.

Each axle-rod may have crank handles on both ends of the rod outside the housing. One of the axle-rods may have a right-end crank handle and an adjacent of the axle-rods having a left-end crank handle.

The housing may include a wait having a front panel pivotally attached thereto. The housing may include a wall having a front panel pivotally attached thereto, the front panel having an enclosure section pivotally attached thereto.

Besides the apparatus disclosed herein, the invention also include a method of using such a device with the free end of fishing line on a fishing reel spool. The method may include the steps of:

(a) attaching the free end of the fishing line on the fishing reel spool to a spool of an axle-rod;

(b) cranking the axle-rod to wind the line onto the spool;

(c) detaching the fishing line from the fishing reel spool, and attaching the newly-freed end of the fishing line to another axle-rod spool aligned with the first-mentioned axle-rod spool, and

(d) cranking the other axle-rod to wind the line onto the spool.

I claim:

1. A device for storing fishing line, comprising a housing supporting at least one essentially parallel pair of first and second axle-rods supporting respective aligned first and second spools each for accepting fishing line fed thereon from an angle not substantially parallel to an axle-rod, each axle-rod having a crank handle.

2. The device of claim 1, said housing supporting at least one parallel pair of first and second axle-rods supporting a plurality of pairs of respective aligned first and second spools each for accepting fishing line fed thereon.

3. The device of claim 1, said housing supporting a plurality of essentially parallel pairs of first and second axle-rods supporting respective aligned first and second spools each for accepting fishing line fed thereon from an angle not substantially parallel to an axle-rod.

4. The device of claim 3, each such parallel pair of first and second axle-rods supporting a plurality of pairs of respective aligned first and second spools each for accepting fishing line fed thereon.

5. The device of claim 1, each spool further comprising a line anchoring means for anchoring the end of the line to said spool.

6. The device of claim 1, each axle-rod having crank handles on both ends of said rod outside said housing.

7. The device of claim 1, the first axle-rod having a right-end crank handle and the second axle-rod having a left-end crank handle.

8. The device of claim 1, said housing comprising a pair of opposing support walls connected by a connecting plate.

9. The device of claim 8, each of said support walls defining an aperture aligned with an aperture of the other support wall, for accepting opposite ends of an axle-rod inserted therethrough.

10. The device of claim 9, said housing further comprising a front wall and a rear wall connected to said connecting plate, and a lid pivotally attached to said front wall or said rear wall.

11. The device of claim 1, further comprising indicia for indicating an identifying characteristic of the line spooled thereon.

12. The device of claim 1, wherein the free end of line wound around one of said spools is free to be attached to the other aligned spool for winding around said other spool.

13. A device for storing fishing line, comprising a housing supporting a plurality of axle-rods, each having a crank-handle at one end and supporting a plurality of spools each of which is aligned with a spool supported by an adjacent axle-rod, each of said spools accepting fishing line fed thereon from an angle not substantially parallel to an axle-rod.

14. The device of claim 13, said spool further comprising a tine anchoring means for anchoring the end of the line to said spool.

15. The device of claim 14, each axle-rod having crank handles on both ends of said rod outside said housing.

16. The device of claim 14, one of said axle-rods having a right-end crank handle and an adjacent of said axle-rods having a left-end crank handle.

17. The device of claim 14, said housing comprising a wall having a front panel pivotally attached thereto.

18. The device of claim 14, said housing comprising a wall having a front panel pivotally attached thereto, said front panel having an enclosure section pivotally attached thereto.

19. A method of using a device of claim 13 with the free end of fishing line on a fishing reel spool, comprising the steps of:
(a) attaching the free end of the fishing line on the fishing reel spool to a spool of an axle-rod;
(b) cranking said axle-rod to wind the line onto said spool;
(c) detaching the fishing line from the fishing reel spool and attaching the newly-freed end of said fishing line to another axle-rod spool aligned with said first-mentioned axle-rod spool; and
(d) cranking said other axle-rod to wind the line onto said spool.
